(19) United States
(12) Patent Application Publication
(10) Pub. No.: US 2016/0142888 A1
(43) Pub. Date: May 19, 2016

(54) COMMUNICATION DEVICE FOR VEHICLE

(71) Applicant: HYUNDAI MOTOR COMPANY, Seoul (KR)

(72) Inventor: Sung Hwan MOON, Seoul (KR)

(21) Appl. No.: 14/685,377

(22) Filed: Apr. 13, 2015

(30) Foreign Application Priority Data
Nov. 17, 2014 (KR) 10-2014-0160187

(51) Int. Cl. H04W 4/12; H04M 3/42; H04W 4/16; H04L 29/08; H04L 29/06

(52) U.S. Cl. CPC H04W 4/12; H04L 67/12; H04L 69/16; H04W 4/16; H04M 3/42

(57) ABSTRACT

A communication device for a vehicle includes a telecommunication company server configured to transmit a wake-up message of a vehicle terminal. A telematics server is configured to transmit a transmission request of the wake-up message to the telecommunication company server and to transmit a wake-up voice call to the vehicle terminal when a response signal to the wake-up message is failed.

### CROSS-REFERENCE TO RELATED APPLICATION

The present application claims the benefit of priority of Korean patent application No. 10-2014-0160187 filed on Nov. 17, 2014, the disclosure of which is hereby incorporated in its entirety by reference, is claimed.

### TECHNICAL FIELD

The present disclosure relates to a communication device for a vehicle capable of increasing a success rate by a center triggered service.

### BACKGROUND

As wireless communication services have become more diversified, mobile telecommunication and location tracking systems have been embedded in many vehicles, and the demand for a telematics service has been rapidly increasing. The telematics service combines a vehicle navigation system for providing real-time traffic information and various traffic information services, a remote vehicle diagnosis service for informing a user of the presence or absence of vehicle malfunction, a vehicle position tracking service based on GPS, and additional information services for providing various information.

Since the vehicles have been used widely as daily necessities, various convenient facilities for vehicles have been provided. Various multimedia devices (e.g., compact disc (CD) or compact disc changer (CDC), navigation, radio, TV, etc.) may be equipped in the vehicles.

A conventional vehicle generates a door-lock release signal when a user or driver opens a vehicle door with a key, so that the multimedia system can rapidly start. As soon as the user seats on a driver's seat, the user can immediately manipulate desired multimedia devices, resulting in greater convenience of use.

The above-mentioned conventional vehicle has been designed to wake-up the multimedia devices when the user opens the door with the key. If the user opens the door but does not present near the vehicle, the multimedia devices however continuously stay in a standby mode, and thus, a dark current of the vehicle may be continuously consumed.

In addition, if the vehicle door is open, the multimedia devices can wake-up, and it takes a long period of time to boot a plurality of multimedia devices. As a result, the multimedia devices do not start booting up until the driver puts the key in the ignition lock and turns it such that there is a delay for the user for operating the multimedia devices.

In order to address the above-mentioned issues, there has been recently proposed a telematics technology which enables the driver to perform vehicle remote diagnosis through a wireless network, and thus wakes-up the multimedia devices embedded in a vehicle through wireless communication with a communication terminal located in the vehicle.

### SUMMARY

An aspect of the present inventive concept provides a communication device for a vehicle that substantially obviates one or more problems due to limitations and disadvantages of the related art.

The present invention relates to a technology for increasing a success rate by a center triggered service using a voice wake-up call technology for a Telematics service of a vehicle.

In accordance with an embodiment of the embodiment, a communication device for a vehicle includes a mobile telecommunication company server configured to transmit a wake-up message of a vehicle terminal; and a telematics server configured to transmit a transmission request of the wake-up message to the mobile telecommunication company server, and transmit a wake-up voice call to the vehicle terminal when a response signal to the wake-up message is failed.

It is to be understood that both the foregoing general description and the following detailed description of the present disclosure are exemplary and explanatory and are intended to provide further explanation of the invention as claimed.

### BRIEF DESCRIPTION OF THE DRAWINGS

FIG. 1 is a block diagram illustrating a communication device for a vehicle according to an embodiment of the present inventive concept.

FIGS. 2 and 3 illustrate operations of the communication device for a vehicle according to an embodiment of the present inventive concept.

### DETAILED DESCRIPTION

Reference will now be made in detail to the embodiments of the present inventive concept, examples of which are illustrated in the accompanying drawings. Wherever possible, the same reference numbers will be used throughout the drawings to refer to the same or like parts.

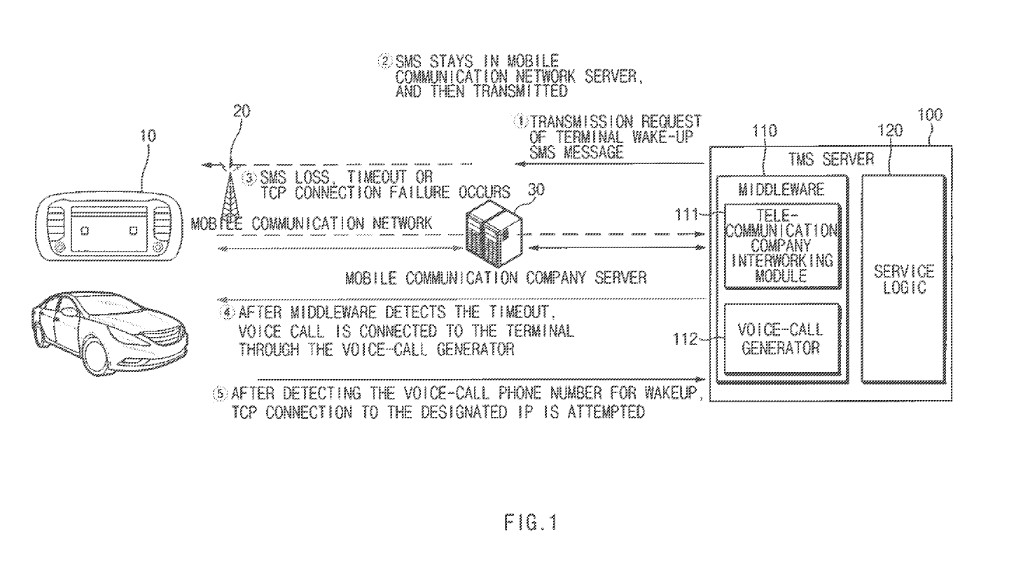

FIG. 1 is a block diagram illustrating a communication device for a vehicle according to an embodiment of the present inventive concept.

Referring to FIG. 1, the vehicle communication device includes a vehicle terminal 10, a mobile telecommunication network 20, a mobile telecommunication company server 30, and a telematics (TMS) server 100. The TMS server 100 may include a middleware 110 and a service logic 120. The middleware 110 may include a mobile telecommunication company interworking module 111, and a voice-call generator 112.

Although the voice-call generator 112 of the present disclosure is exemplarily contained in the middleware 110 for the convenience of description and better understanding of the present inventive concept, the scope or spirit of the present disclosure is not limited thereto, and the voice-call generator 112 may be implemented as an additional server separately from the middleware 110.

The vehicle terminal 10 may include a variety of multimedia devices, for example, a compact disc (CD) or compact disc changer (CDC), navigation, radio, TV, etc. embedded in the vehicle.

The mobile telecommunication company server 30 interworks with the TMS server 100, such that it can transmit information received from the mobile telecommunication company interworking module 111 to the vehicle terminal 10 through a short message service (SMS).

The TMS server 100 may communicate wirelessly with the vehicle terminal 10, and may request the mobile telecommunication company server 30 to transmit a SMS message for waking-up the vehicle terminal 10. If a response signal to transmission of the SMS message received from the vehicle terminal 10 has failed, the TMS server 100 may provide a voice call service to the vehicle terminal 10 through the voice-call generator 112.

The term “wake-up” for use in the embodiment may include a center-triggered message for inducing transmission control protocol (TCP) connection to the center, and include a message for terminating a sleep mode (terminal idle state) and starting the terminal operation.

The service logic 120 may perform overall service operations needed to wirelessly communicate with the vehicle terminal 10 via the TMS server 100.

In a vehicle for which all internet protocols (IPs) are not supported, the SMS wake-up message service is used to perform TCP communication with the vehicle terminal 10.

The vehicle terminal 100 is not always turned on, differently from mobile phones. Therefore, if the external TMS server 100 desires to transmit a message to the vehicle terminal 10, it is necessary to drive a modem of the vehicle terminal 10 using the SMS. This SMS will hereinafter be referred to as a “wake-up SMS”.

The service for waking-up the terminal 10 using the SMS may cause unexpected problems (e.g., a time-out, SMS loss, etc.) due to queueing of the telecommunication company server 30.

The above-mentioned problem is caused by insufficiency of SMS real-time characteristics, so that the Telematics wake-up service based on a voice call is used to address the above-mentioned issue. Therefore, the communication device according to the present disclosure can reduce a failure rate of center triggered TMS service caused by insufficiency of SMS realtime characteristics.

That is, the TMS server 100 may include a mobile telecommunication company interworking module 111 capable of interworking with the mobile telecommunication company server 30, so that the TMS server 100 may transmit a wake-up message (SMS) to the vehicle terminal 10 using the mobile telecommunication company interworking module 111.

The mobile telecommunication company interworking module 111 may implement different SMS transfer protocols for respective mobile telecommunication companies, so that it can transmit appropriate SMS messages for unique protocols of regions and telecommunication companies.

The present disclosure has exemplarily disclosed that the mobile telecommunication company interworking module 111 transmits the SMS message to the mobile telecommunication company server 30.

However, the scope or spirit of the present disclosure is not limited thereto, and messages transferred from the mobile telecommunication company interworking module 111 to the mobile telecommunication company server 30 may be comprised of a long message service (LMS), a multimedia message service (MMS), etc. In addition, the above-mentioned messages may further include other messages capable of being received in an idle state of the TCP transmission/reception functions of the vehicle terminal 10.

Here, the mobile telecommunication company interworking module 111 may be contained in the middleware 110. The middleware 110 may interconnect different kinds of hardware or protocols, a communication environment, etc. in the distributed computing environment, so that application programs can easily communicate with the associated program management environment.

The SMS message requested to be transmitted from the mobile telecommunication company interworking module 111 is transmitted to the mobile telecommunication company server 30. Thereafter, the SMS message is applied to each objective terminal according to the specifications of the mobile telecommunication company server 30.

However, the mobile telecommunication company server 30 may store the SMS message in a queue, and transmit the queue. Therefore, the corresponding SMS message may stay in the SMS message queue of the mobile telecommunication company server 30 until reaching its own transmission order.

Although the mobile telecommunication company server 30 can provide a high success rate (e.g., 97% or higher) of message transmission, it should be noted that the mobile telecommunication company server 30 may also include a low failure rate (e.g., 3% or less) of message transmission. In addition, considering other cases in which the TMS service failure caused by transmission delay occurs, the high success rate of message transmission cited by the mobile telecommunication company server 30 may not be high.

In addition, a service time-out time may be predefined in the TMS server 100. The service time-out time is requisite for efficient management of securities and server resources.

In order to address the above-mentioned issue, the communication device according to the present disclosure can wake-up the vehicle terminal 10 through the SMS transmission service and the voice call service capable of providing real-time characteristics.

The mobile telecommunication company interworking module 111 contained in the middleware 110 of the TMS server 100 may transmit the wake-up SMS message transmission request to the mobile telecommunication company server 30.

Thereafter, the mobile telecommunication company server 30 may store the SMS message in the SMS queue, and may transmit the SMS message to the vehicle terminal 10 through the mobile telecommunication network 20.

Therefore, if the mobile telecommunication company server 30 transmits the SMS message to the vehicle terminal 10, the SMS may be lost. In addition, when the SMS message is transmitted to the vehicle terminal 10, timeout may occur, or TCP connection failure may also occur.

In this case, the middleware 110 of the TMS server 100 may detect timeout of the SMS message. The voice-call generator 110 may connect the voice cell service to the vehicle terminal 10, and thus wake-up the vehicle terminal 10.

Thereafter, if the voice cell service for wake-up is connected, the vehicle terminal 10 detects a phone number to call, and attempts to perform TCP connection to a designated IP, such that the vehicle terminal 10 can communicate with the TMS server 100.

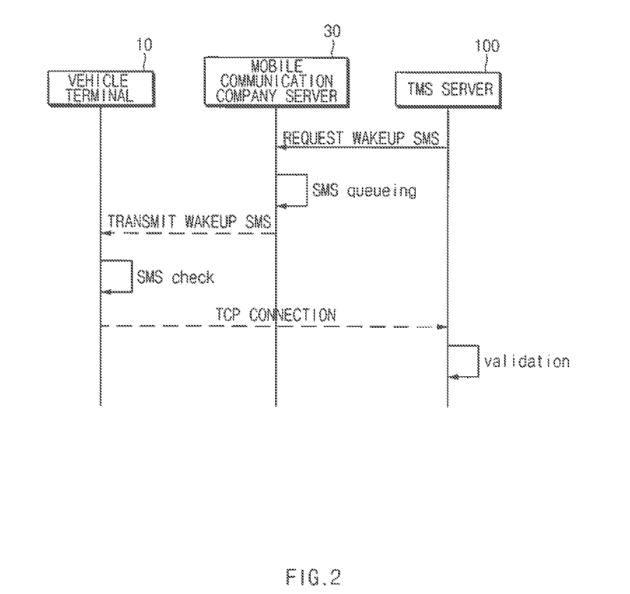

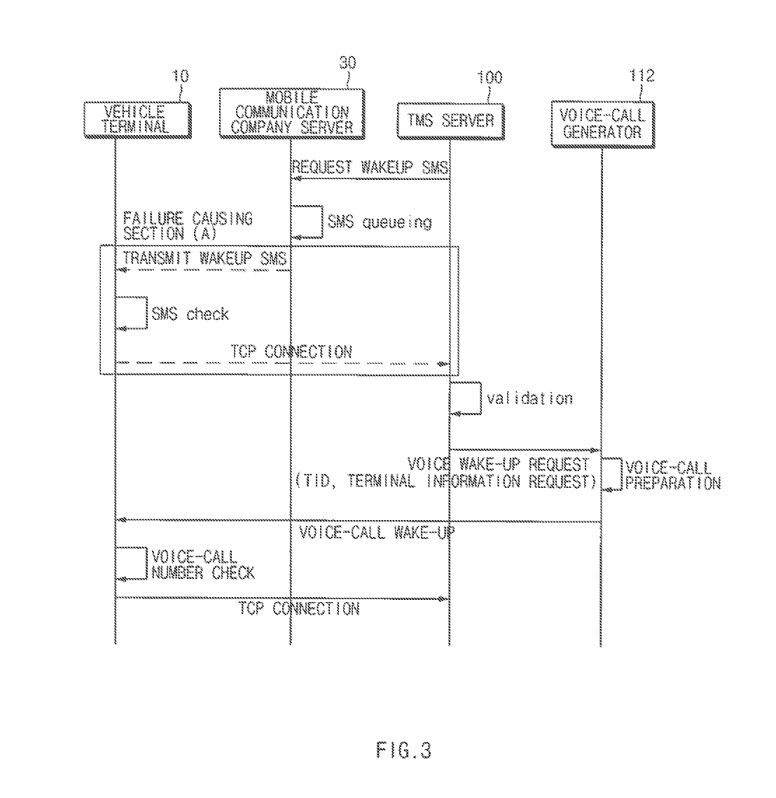

FIGS. 2 and 3 illustrate operations of the communication device for a vehicle according to an embodiment of the present inventive concept.

FIG. 2 is a flowchart illustrating a method for allowing the vehicle terminal 10 and the TMS server 100 to transmit/receive the SMS message. FIG. 3 is a flowchart illustrating a method for allowing the TMS server 10 and the TMS server 100 to perform the voice call wake-up service.

Referring to FIG. 2, the mobile telecommunication company interworking module 111 of the TMS server 100 may transmit a transmission request of a wake-up SMS message to the mobile telecommunication company server 30. The mobile telecommunication company server 30 may store the SMS message in the SMS queue, and may transmit the wake-up SMS message to the vehicle terminal 10 through the mobile telecommunication network 20.

If the mobile telecommunication company server 30 transmits the wake-up SMS message to the vehicle terminal 10, the SMS message may be lost by the mobile telecommunication company server 30.

In addition, if the SMS message is transmitted to the vehicle terminal 10, the terminal may check the received SMS message. In this case, since a predetermined time is consumed for the mobile telecommunication company server 30 configured to store the SMS message in the SMS queue, timeout may occur.

Thereafter, the vehicle terminal 10 may transmit a response signal to the wake-up SMS message to the TMS server 100 through TCP communication. The TMS server 100 may validate the message received from the vehicle terminal 10. In this case, a TCP connection failure may occur according to the SMS queue time of the mobile telecommunication company server 30, or the timeout of the TMS server 100 may occur.

Therefore, a message-transmission-failure causing section may occur among the vehicle terminal 10, the mobile telecommunication company server 30, and the TMS server 100 in the (A) section as shown in FIG. 3.

Here, the TMS server 100 may include a separate gateway in the middleware 110 to validate the failure of the message received through the TCP from the vehicle terminal 10. The TMS server 100 may validate the IP for the vehicle terminal 10 through this gateway.

If the TMS server 100 fails to validate the SMS message, the middleware 110 of the TMS server 100 may transmit a voice wake-up request to the voice-call generator 112.

The middleware 110 may transmit transaction ID (TID) information indicating a unique identifier (ID) of the service corresponding to the voice-call generator 112, and may request information of the terminal. That is, respective components of the TMS server 100 are interconnected through an internal network (or a wired network), so that information regarding the service history management can communicate between systems. Therefore, the TMS service log-in continuation is maintained to implement the service tracking.

The voice-call generator 112 is ready to perform the voice call service, and transmits the wake-up voice call to the corresponding vehicle terminal 10. The communicator of the vehicle terminal 10 may check a phone number corresponding to the voice call received from the voice-call generator 112.

The communication bus of the vehicle terminal 10 may identify a call sender (i.e., a caller) in various ways. In this case, the voice call sender may be identified using a caller phone-number, a dial tone, etc.

After completion of the voice call, a communication bus of the vehicle terminal 10 attempts to perform TCP connection to the IP address of the predetermined TMS server 100, and transmits a response signal to the wake-up message to the TMS server 100.

As is apparent from the above description, the vehicle communication device according to the embodiments can increase a success rate of a center triggered service using a voice wake-up call technology.

The above-mentioned embodiments are merely exemplary for better understanding of the present inventive concept, and the scope of the present inventive concept is not limited thereto. For example, a single component may be divided into two or more components, or two or more components may be combined into a single component as needed.

What is claimed is:

1. A communication device for a vehicle, comprising:
a mobile telecommunication company server configured to transmit a wake-up message of a vehicle terminal; and
a telematics (TMS) server configured to transmit a transmission request of the wake-up message to the mobile telecommunication company server and to transmit a wake-up voice call to the vehicle terminal when a response signal to the wake-up message is failed.

2. The communication device according to claim 1, wherein the wake-up message includes any one of a short message service (SMS), a long message service (LMS), and a multimedia message service (MMS).

3. The communication device according to claim 1, wherein the TMS server determines whether the response signal is failed by validating a transmission control protocol (TCP) transmitted from the vehicle terminal.

4. The communication device according to claim 1, wherein the TMS server includes a voice-call generator configured to generate the wake-up voice call.

5. The communication device according to claim 4, wherein the TMS server transmits transaction ID (TID) information and terminal information to the voice-call generator to request a voice call from the voice-call generator.

6. The communication device according to claim 4, wherein the voice-call generator is contained in a middleware of the TMS server.

7. The communication device according to claim 1, wherein the vehicle terminal includes a communication bus that identifies a call sender by identifying at least one of a caller phone-number and a dial tone during transmission of the wake-up voice call.

8. The communication device according to claim 1, wherein the vehicle terminal includes a communication bus that attempts to connect to a predetermined transmission control protocol (TCP) by checking a phone number of the wake-up voice call.

9. The communication device according to claim 1, wherein the TMS server further includes:
a mobile telecommunication company interworking module configured to interact with the mobile telecommunication company server.

10. The communication device according to claim 9, wherein the TMS server comprises:
a middle ware in which the telecommunication company interworking module and the voice-call generator are included; and
a service logic for performing an overall service operation needed to wirelessly communicated with the vehicle terminal.

11. The communication device according to claim 1, wherein the TMS server is configured to include a predetermined service time-out time

12. The communication device according to claim 10, wherein the mobile telecommunication company server stores the wake-up message in a queue and transmits the wake-up message to the vehicle terminal through a mobile telecommunication network.

13. The communication device according to claim 12, wherein the middleware of the TMS server detects timeout of the message.
